(19) United States
(12) Patent Application Publication
(10) Pub. No.: US 2014/0006408 A1
(43) Pub. Date: Jan. 2, 2014

(54) IDENTIFYING POINTS OF INTEREST VIA SOCIAL MEDIA

(71) Applicants: Adam Rae, Barcelona (ES); Vanessa Murdock, Barcelona (ES); Hugues Bouchard, Montreal (CA); Adrian Popescu, Montrouge (FR)

(72) Inventors: Adam Rae, Barcelona (ES); Vanessa Murdock, Barcelona (ES); Hugues Bouchard, Montreal (CA); Adrian Popescu, Montrouge (FR)

(73) Assignee: Yahoo! Inc., Sunnyvale, CA (US)

(21) Appl. No.: 13/539,144

(22) Filed: Jun. 29, 2012

(51) Int. Cl. G06F 17/30

(52) U.S. Cl. 707/740; 707/E17.089

(57) ABSTRACT

Example methods, apparatuses, or articles of manufacture are disclosed that may be implemented, in whole or in part, using one or more computing devices to facilitate or otherwise support one or more processes or operations for identifying points of interest in a text, such as in an unstructured text, for example, in connection with bootstrapping points of interest via social media.

### BACKGROUND

1. Field

The present disclosure relates generally to search engine content management systems and, more particularly, to identifying points of interest via social media for use in or with search engine content management systems.

2. Information

The Internet is widespread. The World Wide Web or simply the Web, provided by the Internet, is growing rapidly, at least in part, from the large amount of content being added seemingly on a daily basis. A wide variety of content, such as one or more electronic documents, for example, is continually being identified, located, retrieved, accumulated, stored, or communicated. In some instances, electronic documents may comprise, for example, one or more geographic locations, such as landmarks, hotels, parks, pubs, restaurants, etc., or any other suitable geographic points that may be of interest to a particular user. Effectively or efficiently identifying or locating points of interest on the Web may facilitate or support information-seeking behavior of users, for example, and may lead to an increased usability of a search engine. In addition to locating, retrieving, identifying, etc. electronic documents, search engines may, for example, employ one or more functions or processes to rank retrieved documents using one or more ranking measures.

In some instances, coverage of points of interest, such as on the Web, for example, may be biased towards more populous geographic areas that may be easier or less expensive to access or survey, areas dominated by larger businesses with advertising or listing budgets, areas with more prominent landmarks or services that are less likely to change locations (e.g., hospitals, universities, etc.), or the like. As such, points of interest with respect to relatively smaller businesses or more ephemeral places, such as neighborhood pubs, family restaurants, bed-and-breakfast inns, or the like may, for example, be underrepresented in certain geographic or location databases or like repositories accessible by search engines.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a schematic diagram illustrating certain features of an implementation of an example computing environment.

FIG. 2 is a schematic representation of a flow diagram illustrating a summary of an implementation of an example process for establishing a POI tagger.

FIG. 3 is a flow diagram illustrating an implementation of an example process that may be performed in connection with bootstrapping POIs via social media.

FIG. 4 is a schematic diagram illustrating an implementation of a computing environment associated with one or more special purpose computing apparatuses.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

Some example methods, apparatuses, or articles of manufacture are disclosed herein that may be used, in whole or in part, to facilitate or support one or more processes or operations for identifying points of interest in a text, such as in an unstructured text, for example, in connection with bootstrapping points of interest via social media. As used herein, “social media” may refer to on-line content generated or communicated, at least in part, via or in connection with a user-related engagement or interaction. In some instances, social media may comprise, for example, content generated or communicated via or in connection with a social grouping or arrangement, such as a social-type network (e.g., Facebook®, MySpace®, LinkedIn®, etc.), social-type portal or service (e.g., Wikipedia®, Yelp®, etc.), location check-in service (e.g., Gowalla®, Foursquare®, etc.), or the like. “On-line,” as the term used herein, may refer to a type of a communication that may be implemented electronically, such as via one or more suitable communications networks (e.g., wireless, wired, etc.). As a way of illustration, communication networks may include the Internet, an intranet, a communication device network, just to name a few examples.

A content management system may comprise, for example, a search engine that may help a user to locate or retrieve on-line content. As alluded to previously, in some instances, on-line content may include, for example, one or more electronic documents comprising one or more geographic points of a particular interest. As used herein, the terms “electronic document” or “web document” may be used interchangeably and may refer to one or more digital signals, such as communicated or stored signals, for example, representing content regardless of form including a source code, text, image, audio, video file, or the like. Web documents may, for example, be processed by a special purpose computing platform and may be played or displayed to or by a user, member, or client. The terms like “user,” “member,” or “client” may be used interchangeably herein. At times, web documents may include one or more embedded references or hyperlinks to images, audio or video files, or other web documents. For example, one common type of reference may comprise a Uniform Resource Locator (URL). As a way of illustration, web documents may include a web page, an electronic user profile, a news feed, a rating or review post, a status update, a portal, a blog, an e-mail, a text message, a link, an Extensible Markup Language (XML) document, a media file, a web page pointed or referred to by a URL, just to name a few examples.

As used herein, the term “point of interest” (POI) should be interpreted broadly and may refer any geographic point that may be of interest, such as to a user for a given context, for example. At times, a POI may be representative of any suitable geographic location, such as, for example, a structure in a city, feature of the land, geographic region, or the like. By way of example but not limitation, POIs may include, for example, hotels, museums, parks, pubs, restaurants, landmarks, businesses, services, schools, hospitals, airports, or the like. As was indicated, POIs may, for example, at least partially comprise a basis for content underlying many location-related recommender services, social networking applications, search engine content management systems, or the like. For example, in some instances, it may be useful for a local search or recommender system to know POIs in a city in order to understand a user's geographic context so as to better serve relevant search results to an associated mobile device.

One typical approach to POI derivation may include sending a surveyor, such as employed by a company curating location content (e.g., Navteq, TeleAtlas, etc.), for example, to a location to identify, verify, record, etc. POIs. At times, a surveying process may be relatively expensive and, although it may yield a higher-quality or accuracy location content, it may become stale relatively quickly. For example, once documented, some location content may have a relatively limited temporal validity, such as due to location, business changes, or the like. As such, POIs documented via this approach may tend to comprise geographic points of a more permanent or long term nature, for example, or these that are less likely to change with time, such as landmarks, schools, hospitals, universities, or the like. As was indicated, this may, for example, create a bias in location content towards more stable or stationary POIs, more populous places that surveyors may access more easily, or the like. As a result, this may reduce coverage of POIs representative of smaller restaurants, neighborhood pubs, bed-and-breakfast inns, or more ephemeral places.

Another typical approach for curating POIs may include, for example, creating a directory of sponsored listings. At times, directories of sponsored listings may, for example, be accessed or otherwise used, at least in part, such as by local search engines, mapping applications, etc. and may facilitate or support locating, retrieving, displaying, etc. suitable on-line content. Here, location content may, for example, be biased towards a POI, such as a business, service, etc. that may have a budget or inclination to list itself with an on-line directory. Thus, in some instances, relatively smaller or independent businesses, services, etc. may, for example, be less likely to be listed. In addition, in some countries, such as with a relatively low Internet usage, for example, sponsored listings may be rather sparse or may be dominated by larger businesses, such as national chains, etc. This bias, such as towards larger or more prominent businesses, services, etc., for example, may not necessarily reflect geographic locations that some users may be interested in.

Typically, although not necessarily, POI detection or identification may be considered an aspect of named-entity recognition (NER) in which an entity to be discovered may comprise a POI, as one possible example. At times, to make a typical NER task more manageable, geographic locations of interest may, for example, be limited to cities, states, or countries. This simplification may at least partially help to reduce ambiguity in an editorial process, for example, or allow a suitable learner function to be trained on a smaller amount of hand-labeled training content. Typically, although not necessarily, “learner function” may refer to an algorithm or process capable of learning to recognize one or more characteristics of interest, such as within a pattern, for example, so as to make intelligent decisions with respect to like or unseen characteristics based, at least in part, on observed examples, such as training datasets. Since POI detection may typically represent a real-world NER task, it may be useful, for example, to utilize or otherwise consider a variety of real-world sources, such as on-line encyclopedias, status updates (e.g., travel-related, etc.), micro-blogging posts or messages, or the like. Although relatively rich or otherwise sufficient with respect to mentions of POIs, at times, these sources may have little in common with each other, however. For example, content associated with these sources may be noisy, of questionable provenance, of variable quality, or the like.

More specifically, certain on-line content that may be useful for POI derivation, such as, for example, news articles, Twitter®-type messages, search queries, etc. may not share certain semantic or distributional properties. As used herein, “Twitter®-type message” may refer to one or more on-line messages that are typically, although not necessarily, a few sentences long, which are not bound by rigid writing rules, styles, or standards. Thus, in some instances, properties associated with on-line content may make it less practical or useful to hand-label a sufficient amount of training datasets, for example, so as to train a suitable POI tagging model or POI tagger. Accordingly, it may be desirable to develop one or more methods, systems, or apparatuses that may facilitate or support POI detection or identification in a more effective of efficient manner in a text, such as, for example, in an unstructured text. This may, for example, expand POI coverage, reduce reliance on sponsored or licensed listings, etc., or otherwise improve detection or identification of location mentions in a NER task.

Accordingly, in an implementation, POI mentions, such as in social media, for example, may be extracted, and a textual context relevant to extracted POI mentions may be obtained. As will be described in greater detail below, a textual context may, for example, be obtained via one or more relevant text snippets or web page abstracts sufficient to contextualize extracted POIs. By obtaining a context in which POIs are used, a more general representation of POIs may, for example, be learned, such as by a learner function. Based, at least in part, on a textual context, one or more suitable features may, for example, be computed. A suitable learner function may be trained, such as via one or more machine-learning techniques, for example, in connection with one or more computed features and may be used, at least in part, to establish one or more POI taggers. In some instances, POI taggers may be employed, at least in part, by a suitable classifier function or process, for example, to identify suitable POIs (e.g., new, previously unseen, etc.) in a text, such as in an unstructured text accessible by a search engine or like information management system responsive to search queries.

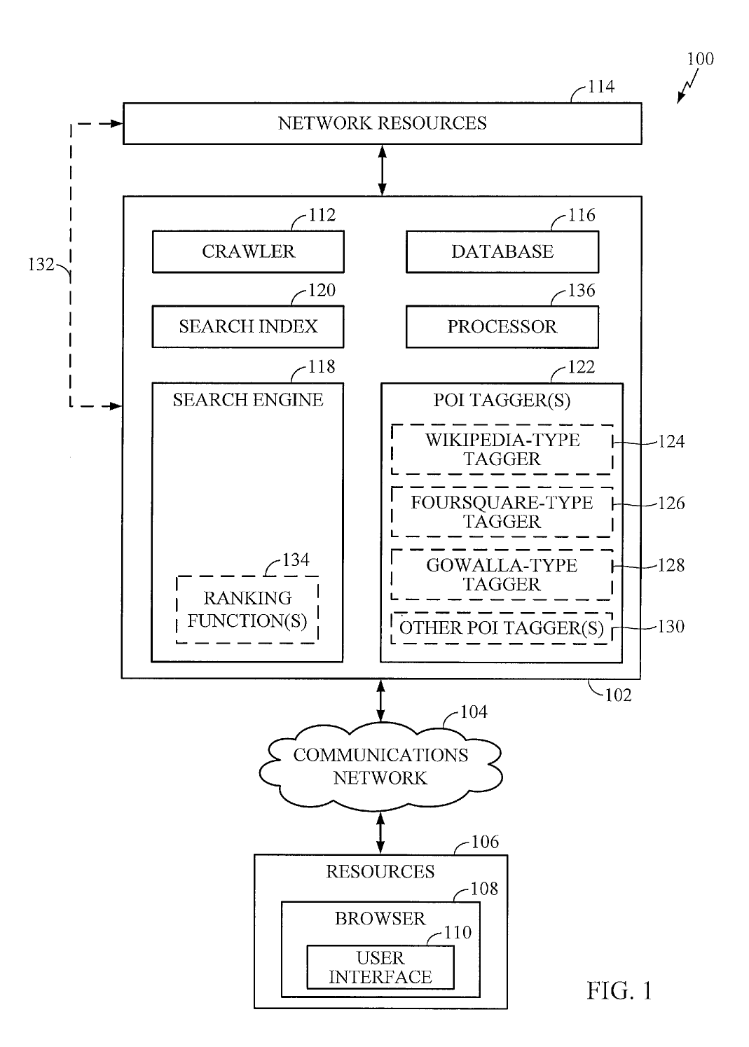

FIG. 1 is a schematic diagram illustrating certain features of an implementation of an example computing environment 100 capable of facilitating or supporting one or more processes or operations for identifying POIs in an unstructured text, such as in connection with bootstrapping POIs via social media, for example. As will be seen, one or more processes or operations may be performed in connection with a bootstrapping scheme, such as a mechanism that may be employed electronically, in whole or in part, to identify one or more POIs using one or more machine-learned models, for example. Computing environment 100 may be operatively enabled using one or more special purpose computing apparatuses, communication devices, storage devices, computer-readable media, applications or instructions, various electrical or electronic circuitry, components, etc., as described herein with reference to example implementations.

As illustrated, computing environment 100 may include one or more special purpose computing platforms, such as, for example, a Content Integration System (CIS) 102 that may be operatively coupled to a communications network 104 that a user may employ to communicate with CIS102 by utilizing resources 106. CIS102 may be implemented in connection with one or more public networks (e.g., the Internet, etc.), private networks (e.g., intranets, etc.), public or private search engines, Real Simple Syndication (RSS) or Atom Syndication (Atom)-type applications, etc., just to name a few examples.

Resources 106 may comprise, for example, one or more special purpose computing client devices, such as a desktop computer, laptop computer, cellular telephone, smart telephone, personal digital assistant, or the like capable of communicating with or otherwise having access to the Internet via a wired or wireless communications network. Resources 106 may include a browser 108 and a user interface 110, such as a graphical user interface (GUI), for example, that may initiate transmission of one or more electrical digital signals representing a search query, for example. User interface 110 may interoperate with any suitable input device (e.g., keyboard, mouse, touch screen, digitizing stylus, etc.) or output device (e.g., display, speakers, etc.) for interaction with resources 106. Even though a certain number of resources 106 are illustrated, it should be appreciated that any number of resources may be operatively coupled to CIS102, such as via communications network 104, for example.

In an implementation, CIS 102 may employ a crawler 112 to access network resources 114 that may include suitable content of any one of a host of possible forms (e.g., web pages, search query logs, status updates, location check-ins, audio, video, image, or text files, etc.), such as in the form of stored binary digital signals, for example. Crawler 112 may store all or part of a located web document (e.g., a URL, link, etc.) in a database 116, for example. CIS 102 may further include a search engine 118 supported by a suitable index, such as a search index 120, for example, and operatively enabled to search for content obtained via network resources 114. Search engine 118 may, for example, communicate with user interface 110 and may retrieve for display via resources 106 a listing of search results (e.g., POIs, etc.) via accessing, for example, network resources 114, database 116, search index 120, etc. in response to a search query. Network resources 114 may include suitable content, as was indicated, such as represented by stored digital signals, for example, accessible via the Internet, one or more intranets, or the like. For example, network resources 114 may comprise one or more web pages, web portals, status updates, electronic messages, databases, or like collection of stored electronic information.

CIS 102 may further include one or more POI taggers, referenced generally at 122, that may help to identify POIs in a text, such as, for example, in an unstructured text. As used herein, “POI tagging model” or “POI tagger” mat refer to one or more operations or processes capable of identification of a word or linguistic character in a corpus, such as a text, for example, as corresponding to a particular POI. In some instances, POI tagging may be performed based, at least in part, on a definition of POI, one or more tags descriptive of POIs, POI context, or the like. Here, “context” may refer to a relationship of a POI to one or more adjacent or related words or characters, such as, for example, in a phrase, sentence, paragraph, or the like. In some instances, POIs may, for example, be identified during one or more indexing or crawling operations, just to illustrate one possible implementation. Optionally or alternatively, POIs may be identified in connection with a real-time search, for example. POI taggers 122 may possibly improve or otherwise affect search query matching to POIs by considering, for example, one or more features derived from a textual context of POI mentions bootstrapped via social media. For example, as described below, POI mentions may be bootstrapped via content including user-generated content, such as Wikipedia® articles as well as Twitter®-type messages generated in connection with location check-in services, such as Foursquare® or Gowalla®. Of course, these are merely examples of social media or check-in services that may be used, at least in part, to bootstrap POIs, and claimed subject matter is not so limited.

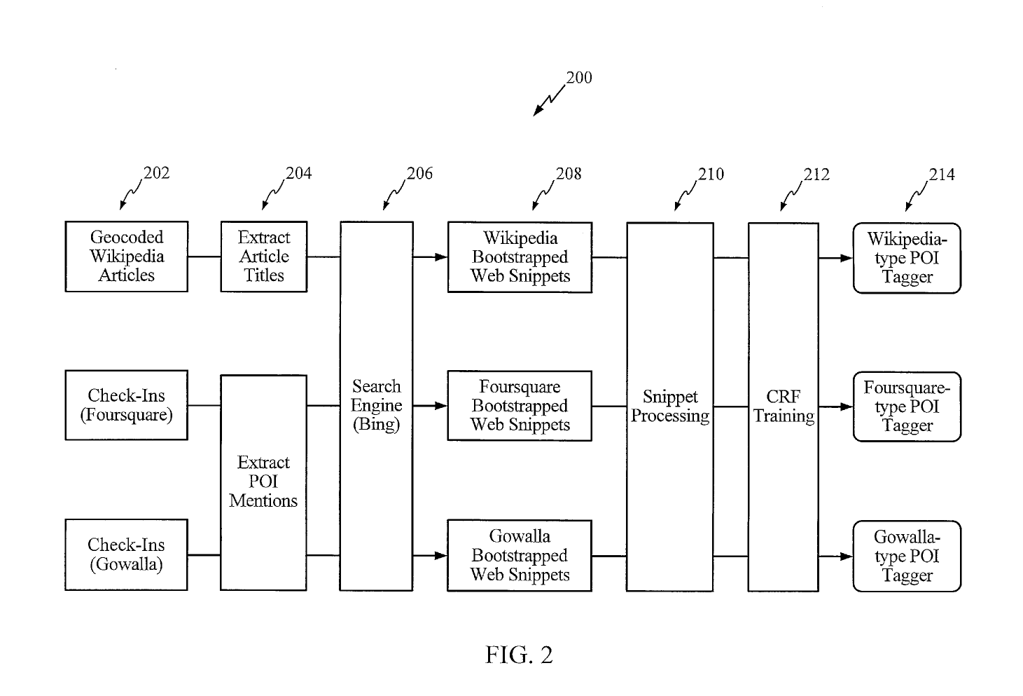

As illustrated, in an implementation, POI taggers 122 may comprise, for example, a Wikipedia®-type tagger 124, a Foursquare®-type tagger 126, or a Gowalla®-type tagger 128, though claimed subject matter is not so limited. Utilization or usefulness of particular POI taggers may, for example, depend, at least in part, on social media used to create a lexicon of POIs (e.g., Wikipedia®, Foursquare®, or Gowalla®-related check-ins, etc.), type of searchable content (e.g., text document, status update, etc.), search engine, or the like. CIS 102 may comprise other POI taggers, referenced at 130, that may facilitate or support one or more operations or processes associated with computing environment 100. POI taggers 122 may be utilized individually or in any suitable combination. Particular examples of POI taggers 122 will be described in greater detail below with reference to FIG. 2.

At times, it may be potentially advantageous to utilize one or more real-time or near real-time indexing or searching techniques, for example, so as to keep a suitable index (e.g., search index 120, etc.) sufficiently updated. In this context, “real time” may refer to an amount of timeliness of content, which may have been delayed by, for example, an amount of time attributable to electronic communication as well as other signal processing. For example, CIS102 may be capable of subscribing to one or more social networking platforms, location check-in services, etc. via a content feed 132. In some instances, content feed 132 may comprise, for example, a live feed, though claimed subject matter is not so limited. As such, CIS102 may, for example, be capable of receiving streaming, periodic, or asynchronous updates via a suitable API (e.g. Facebook®, Foursquare®, Gowalla®, Wikipedia®, etc.) with respect to user check-ins, article posts, or the like. Feed 132 may be optional in certain implementations.

As was indicated, in some instances, it may be desirable to rank retrieved web documents so as to assist in presenting relevant or useful content, such as one or more electronic documents comprising POIs of interest, for example, in response to a search query. Accordingly, CIS102 may employ one or more ranking functions 134 that may rank search results in a particular order that may be based, at least in part, on keyword, relevance, recency, usefulness, popularity, or the like including any combination thereof. As illustrated, CIS102 may further include a processor 136 that may, for example, be capable of executing computer-readable code or instructions, implement suitable operations or processes, etc. associated with example environment 100.

In operative use, a user may access a search engine website, such as www.yahoo.com, for example, and may submit or input a search query by utilizing resources 106. Browser 108 may initiate communication of one or more electrical digital signals representing a search query from resources 106 to CIS 102, such as via communications network 104, for example. CIS 102 may, for example, look up search index 120 and may establish a listing of web documents comprising one or more POIs relevant to a search query based, at least in part, on one or more POI taggers 122, ranking function(s) 134, or the like. CIS 102 may communicate search results to resources 106 for displaying via user interface 110, for example.

FIG. 2 is a schematic representation of a flow diagram illustrating a summary of an implementation of an example process 200 that may facilitate or support one or more operations or techniques for generating or establishing one or more POI taggers, such as in connection with bootstrapping POIs via social media, for example. As was indicated, POI taggers may be utilized, at least in part, for identifying suitable POIs, such as new or previously unseen POIs, for example, in a text including an unstructured text. It should be noted that electronic information applied or produced, such as, for example, inputs or results associated with process 200 may be represented via one or more digital signals. It should also be appreciated that even though operations are illustrated or described concurrently or with respect to a certain sequence, other sequences or concurrent operations may also be employed. In addition, although the description below references particular aspects or features illustrated in certain other figures, one or more operations may be performed with other aspects or features.

At operation 202, one or more suitable sources, such as on-line sources with mentions of POIs may, for example, be selected. As illustrated, in one particular implementation, sources may include, for example, Wikipedia® articles as well as Twitter®-type messages generated in connection with location check-in services, such as Foursquare® or Gowalla®. Potential advantages of utilizing Wikipedia® articles may include, for example, a capability to train a POI tagger from unlabeled Wikipedia® content. This may facilitate or support identifying or discovering POIs in a text including an unstructured text of relatively cleaner (e.g., semantically, etc.) or otherwise less noisy on-line content, such as, for example, news articles, magazines, research papers, or other Wikipedia®-like sources. Utilization of Twitter®-type messages generated in connection with location check-in services, such as Foursquare®, Gowalla®, or the like may also provide potential advantages, such as relatively broader POI coverage (e.g., more mentions of remote or ephemeral places, etc.), for example, as well as a bias towards places that users actually visit. Of course, particular sources of POI mentions or their potential advantages are merely examples, and claimed subject matter is not so limited. Any other suitable sources may be used, in whole or in part.

In an implementation, to facilitate or support POI identification, geo-coded Wikipedia® articles as well as geo-coded Twitter®-type messages may, for example, be used, at least in part. For example, in some instances, one or more Wikipedia® web pages relating to POIs may be identified, at least in part, via or in connection with a semantic knowledge base, such as YAGO2, available at http://www.mpi-inf.mpg.de/yago-naga/yago. For purposes of explanation, the YAGO2 ontology merges content derived from various sources, such as Wikipedia®, WordNet, or GeoNames and, as such, may provide concordance between content of interest and suitable geographic locations, such as Wikipedia® articles and GeoNames geographic entities, for example. The GeoNames geographical database, accessible at http://www.geonames.org, encodes geographic entities with a feature code that classifies entities according to an entity taxonomy. Codes are grouped into nine classes, labeled with a class code letter. By way of example but not limitation, in one particular implementation, Wikipedia® articles labeled with the GeoNames “S” class may be selected or otherwise considered. Typically, an “S” class comprises feature codes that may encompass entities, such as airports, buildings, facilities, as well as historical or industrial sites. As such, this class may correlate or correspond more closely with geographic locations of interest, such as POIs. In some instances, a title text of identified Wikipedia® articles may, for example, be used, at least in part, as a surrogate for a name of a POI, as will be seen. Of course, this is merely an example of selecting suitable on-line sources, such as Wikipedia® articles relating to POIs, for example, and claimed subject matter is not so limited.

As alluded to previously, POI mentions in Wikipedia® may typically, although not necessarily, comprise relatively permanent or longer term structures, such as landmarks, government buildings, or the like sometimes represented via an official name. Accordingly, to facilitate or support POI coverage with respect to more ephemeral places, such as neighborhood bars, local businesses, libraries, museums, or the like, geo-coded Twitter®-type messages generated in connection with location check-in services, such as Foursquare®, Gowalla®, etc. may, for example, be utilized, at least in part. It should be appreciated that Twitter®-type messages or check-ins are used herein as illustrative examples to which claimed subject matter is not limited. For example, in some instances, POI mentions associated with a suitable on-line source, such as Yahoo!® Local listings, Yahoo!® Answers, or the like may be used, at least in part, without deviating from the scope of claimed subject matter. For purposes of explanation, location check-in services, such as Foursquare®, Gowalla®, etc. may allow users to advertise their current location by creating a Twitter®-type message that encodes content about where they are (e.g., via geographic coordinates, addresses, etc.), a name of a place where they are (e.g., a POI, etc.), etc. To check in to a location, users may, for example, select from a list of known or pre-existing POIs (e.g., from sponsored or licensed listings, etc.) or may create their own POI. As such, location check-in services may comprise, for example, a suitable source of POI mentions reflecting places users actually visit, such as in the course of daily activity, for example. Again, this is merely an example relating to on-line sources of suitable POI mentions, and claimed subject matter is not so limited.

At operation 204, one or more Wikipedia® article titles as well as POI mentions associated with Twitter®-type messages generated in connection with one or more location check-in services, such as Foursquare® or Gowalla®, for example, may be extracted. As used herein, “extract” or “extracting” may refer to one or more electronic harvesting or collecting operations or processes with respect to information of interest (e.g., words, symbols, etc.), such as from suitable on-line information sources, for example. As was indicated, in some instances, a title text of identified Wikipedia® articles may, for example, be extracted as a surrogate for a name of a POI, just to illustrate one possible implementation. In addition, POI mentions in Twitter®-type messages may tend to be relatively formulaic and, as such, may be extracted relatively reliably, such as, for example, using one or more regular expressions. Typically, although not necessarily, “regular expression” may refer to a pattern that characterizes or specifies one or more sets of strings of text or like sequence of symbols and denotes operations over these one or more sets (e.g., match, substitute, quantify, etc.). Regular expressions are generally known and need not be described here in greater detail. In some instances, location check-ins to POIs, such as pre-existing POIs, for example, may be utilized, at least in part. After being extracted (e.g., from a text of a Twitter®-type message, title of an article, etc.), in some instances, POIs may, for example be used, at least in part, as seed queries to a suitable search engine so as to contextualize corresponding location mentions, as described below.

Although extracted location mentions, such as POI names in Twitter®-type messages, for example, may be used, at least in part, to create a lexicon of POIs, in some instances, POI check-ins may not be sufficiently useful for training a learner function so as to generate or establish a suitable POI tagger. More specifically, at times, POI check-ins may, for example, lack a textual context sufficiently useful for training a suitable POI tagger due, at least in part, to their short length, informal nature, terse or formulaic appearance, or the like. For example, in certain simulations or experiments, it has been observed that even if there may be a textual context surrounding a POI mention in a Twitter®-type message, it may not be sufficiently informative to satisfactorily estimate a model. Likewise, although in a proper or canonical form, at times, mentions of POIs in titles of Wikipedia® articles may lack a textual context, for example, or may not be sufficiently informative to estimate POI boundaries. Of course, these observations are provided by way of example, and claimed subject matter is not limiter in this regard.

At operation 206, extracted location mentions representative of POIs may, for example, be used, at least in part, as seed queries to a search engine to retrieve relevant web snippets of text. One potential advantage of utilizing seed POI queries may include, for example, obtaining a context in which POIs are used, which may enable a learner function to process or learn a more general representation of a POI, as was indicated. In this context, “obtaining” may refer to one or more operations or processes of identifying or extracting information of interest (e.g., POIs, etc.) from on-line information sources, such as for further processing, for example. In some instances, obtaining may include, for example, information mapping, generating, etc. as well as one or more information transformation operations or processes, such as electronically from a source format into a suitable format. Of course, any suitable search engine may be utilized, at least in part. For example, in one implementation, the application programming interface (API) associated with Bing™ search engine (e.g., http://www.bing.com/toolbox/bingdeveloper) may be used, in whole or in part. By way of example but not limitation, in one particular simulation or experiment, ten search engine snippets were retrieved for an applicable seed POI query so as to obtain sample sentences comprising examples of a textual context surrounding POI mentions in social media. It should be noted that various potentially suitable criteria for selecting samples of sentences may be utilized. For example, in some instances, samples comprising a POI as an exact substring having unextended ASCII characters may be selected. Optionally or alternatively, one or more approximate string matching approaches, non-ASCII characters, etc. may be used or otherwise considered, at least in part. Again, these are merely examples relating to bootstrapping POIs via social media, and claimed subject matter is not so limited.

As illustrated, at operation 208, social media-bootstrapped web snippets, such as Wikipedia®, Foursquare®, or Gowalla®-bootstrapped web snippets, for example, comprising extracted POIs as well as associated usage in context may be obtained. Although not shown, in some implementations, suitable snippets of text, such as one or more sentences using POIs in context may, for example, be obtained from one or more on-line sources, such as original Wikipedia® articles (e.g., without utilizing a search engine, etc.). For example, in certain simulations or experiments, it has been observed that a first few paragraphs of Wikipedia® articles may comprise a set of sentences sufficiently descriptive of POIs so as to provide associated usage in context. For example, locations mentioned in Wikipedia® articles are usually in their canonical form, proper context, etc. and, as such, may be sufficient to ascertain POI entity boundaries. Accordingly, in some instances, a first few paragraphs of Wikipedia® articles, for example, may be segmented into sentences and filtered for those having a POI name. In some instances, an abstract associated with an article of interest, if any, may also be used, at least in part.

With regard to operation 210, retrieved snippets of text may, for example, be processed in some manner and one or more features associated with a context of POI mentions in the retrieved snippets may be computed. More specifically, in some instances, snippets of text may comprise, for example, a sequence of tokens represented via a vector of binary features that may be used, at least in part, to train a learner function to establish a suitable POI tagger. As used herein, “token” may refer to a lexical unit comprising one or more characters. In some instances, a token may comprise, for example, a string of characters, such as a word or like lexical unit separated by space (e.g., a word divider, etc.). As illustrated below, binary features may comprise, for example, observation features as well as state transition features. As used herein, “observation features” may refer to features that may be computed over observations, such as one or more individual tokens, for example. Observation features may comprise, for example, lexical features, geographic features, grammatical features, or statistical features. Lexical features may be computed over a surface text of a token stream, for example, and may characterize a shape or position of a token within a token stream. At times, lexical features may, for example, represent NER-type lexical features comprising a word identity, word shape, position in a sentence, prefix or suffix of a token, or the like.

In one implementation, geographic features may, for example, be computed using Yahoo! Placemaker™, a geographic parsing service, accessible at http://developer.yahoo.com/geo/placemaker, to provide content for tokens that match a POI name. For purposes of explanation, for a token that matches a search entry, Placemaker™ may provide, for example, a list of candidate places to which a token may refer, name variants in different languages, colloquial names, or the like. Characterizing statistics may, for example, be computed over this list.

At times, to encode a grammatical function of a token, part-of-speech tagging may be performed for a token within a sentence using, for example, Apache OpenNLP10 Natural Language Processing Toolkit of a Maximum Entropy Model for Part-Of-Speech (POS) Tagger, accessible at http://incubator.apache.org/opennlp, just to illustrate one possible implementation. In certain simulations or experiments, a Penn English Treebank POS tag dictionary comprising 36 tags was used, though claimed subject matter is not so limited.

In some instances, normalized pointwise mutual information (npmi) may, for example, be computed over token bi-grams appearing in a random sample from one or more Yahoo!® mobile search query logs, as one possible example. For a bi-gram, normalised point-wise mutual information of a token x and its subsequent token y may, for example, be computed as:

$$pmi ( x ; y ) ≡ log \frac{p ( x , y )}{p ( x ) p ( y )} \\ npmi ( x ; y ) = \frac{pmi ( x , y )}{- log [ max ( p ( x ) , p ( y ) ) ]} \qquad ( 1 )$$

To convert npmi into a binary feature, output values may be discretized using any suitable techniques, such as, for example, by applying a “greater-than” threshold test at each 0.1 interval between (−1) and +1, which may result in 20 binary features per bi-gram. Again, claimed subject matter is not limited to this particular test, threshold, features, or the like.

As used herein, “state transition features” may refer to features that may be computed over state transitions, such as one or more tuples comprising one or more tokens, for example. As will be seen, state transition features may facilitate or support identifying relatively longer POIs, such as within a text including, for example, an unstructured text.

By way of example but not limitation, some examples of features computed in connection with one particular simulation or experiment included those illustrated in Table 1 below. It should be appreciated that features shown are merely examples to which claimed subject matter is not limited.

TABLE 1
Example features.

| Feature | Description |
|---|---|
| Word Identity | The raw text representation of the token |
| Normalised Word Identity | The lower case version of Word Identity |
| Word Shape | Indicates capitalisation, and hyphens |
| Word Capitalisation | The first letter of the token is a capital letter |
| Word Position (First) | The token is at the beginning of a sentence |
| Word Position (Last) | The token is at the end of a sentence |
| Word Prefix | First three characters of the token |
| Word Suffix | Last three characters of the token |
| Part-Of-Speech | OpenNLP English language maxent labelling |
| Bi-Gram | Normalised point-wise mutual information |
| | of token and next token |
| Related Location Probability | Probability that token represents a place |
| Related Location Match | True if token matches a place name |
| Related Location Size | Number of place matches it including variants |
| Related Location Unique | Place matches where variants are conflated |
| Related Location Unique | (Related Location Size)/(Related Location |
| Ratio | Unique) |

As illustrated, for state transition features, such as Related Location Probability, Related Location Match, etc., a previous state as well as a next state may, for example, be considered. Some features, such as Word Identity or Word Shape features may, for example, be computed over previous two states as well as next two states, just to illustrate one possible implementation. This may help with or otherwise improve POI recognition with respect to relatively longer formulaic POI names, such as “Church of Saint Martin,” “the Museum of Natural History,” or the like. Of course, these are merely examples relating to suitable POI features, and claimed subject matter is not so limited.

Having computed one or more POI features, at operation 212, a learner function may, for example, be trained so as to establish one or more suitable POI taggers. Although claimed subject matter is not limited in this respect, in some implementations, a sequential tagging function or operation may be used, at least in part. For example, in certain simulations or experiments, it has been observed that Conditional Random Fields (CRF) may comprise a useful function or operation for POI sequence tagging, though claimed subject matter is not so limited. A CRF may, for example, compute a probability of a label sequence y, given an observation sequence x, substantially in accordance with:

$$p ( Y \vert X , λ ) = \frac{1}{Z ( X )} exp ( {\sum }_{j} {λ}_{j} {F}_{j} ( Y , X ) ) \qquad ( 2 )$$

where Z(X) denotes a normalizing factor, and F(Y, X) denotes a set of feature functions or operations computed over observations and label transitions. A learning process may select a set of feature weights Λ, which may improve a label sequence probability P(Y|X), for example, as:

$${argmax}_{Λ} \{ \frac{1}{Z ( X )} exp ( {\sum }_{j} {λ}_{j} {F}_{j} ( Y , X ) ) \} \qquad ( 3 )$$

Thus, a learner function, such as a CRF may, for example, be trained on one or more features extracted from a textual context of POI mentions in social media, such as features illustrated in Table 1, using suitable machine-learning techniques. It should be noted that a learner function may be trained with or without human editorial input. For example, a CRF may be trained in connection with a human assessor (e.g., in a supervised learning mode, etc.), a machine (e.g., in an unsupervised learning mode, etc.), or any combination thereof. In some instances, training content may be labeled in “BIO” notation, such as in a typical NER task, for example, meaning that a token may be labeled as a beginning of a POI mention (B), a continuation of a POI mention (I), or not part of a POI mention (O). Of course, these are merely example details relating to establishing one or more suitable POI taggers, and claimed subject matter is not limited in this regard.

At operation 214, based, at least in part, on training a suitable learner function or model (e.g., a CRF, etc.), one or more POI taggers may, for example, be established. A type of a POI tagger may, for example, depend, at least in part, on social media used to create a lexicon of POIs, snippet processing, computed POI features, learner function, or the like. As illustrated, in some instances, a Wikipedia®-type tagger, a Foursquare®-type tagger, as well as a Gowalla®-type tagger may, for example, be established, though claimed subject matter is not so limited.

By way of example but not limitation, Table 2 below illustrates performance results of POI taggers trained, at least in part, on web snippets bootstrapped via social media and evaluated on human-annotated training content as well as 10-fold cross-validation.

TABLE 2
Example performance results.

| Training Data | Testing Data | Precision | Recall |
|---|---|---|---|
| Yahoo! Placemaker | All Manual Annotations | 0.2372 | 0.2281 |
| Wikipedia † | All Manual Annotations | 0.514 | 0.337 |
| Wikipedia | Known Manual Annotations | 0.447 | 0.397 |
| Wikipedia | New Manual Annotations | 0.521 | 0.324 |
| Foursquare † | All Manual Annotations | 0.276 | 0.655 |
| Foursquare | Known Manual Annotations | 0.215 | 0.735 |
| Foursquare | New Manual Annotations | 0.288 | 0.638 |
| Gowalla † | All Manual Annotations | 0.360 | 0.414 |
| Gowalla | Known Manual Annotations | 0.314 | 0.510 |
| Gowalla | New Manual Annotations | 0.362 | 0.393 |
| Wikipedia | (10-fold c.v.) | 0.879 | 0.955 |
| Foursquare | (10-fold c.v.) | 0.689 | 0.468 |
| Gowalla | (10-fold c.v.) | 0.857 | 0.868 |

As seen, for an implementation, a statistically measurable or otherwise useful improvement in performance using POI taggers trained on web snippets bootstrapped via social media appears to be achieved. More specifically, it appears that bootstrapping POI mentions may improve results for Twitter®-type or like check-in content, for example, and may produce a useful improvement with up to about 56% precision or about 50.8% improvement over state-of-the-art approaches. In addition, it appears that performance of bootstrapped POI taggers on a dataset created by human assessors may be capable of achieving a precision of about 87.2% and a recall of 74.2%, for example. As also illustrated, an upper bound of performance in connection with training on an unlabeled training content may, for example, be achieved in a learned POI extraction. In addition, results of POI taggers trained on bootstrapped web snippet content appear to show that taggers may have a statistically predictable performance since corresponding models are not over-fitted to applicable training content. Again, this may illustrate a statistically measurable or otherwise improved performance over state-of-the-art approaches. In one particular simulation or experiment, it has been observed that if each of three trained models (marked with †) are compared with a baseline Yahoo!® Placemaker evaluation, they may be found to be statistically significantly different, such as, for example, with p-value<0.001 according to McNemar's χ² test. Claimed subject matter is not so limited to such an observation, of course.

Accordingly, as discussed herein, bootstrapping POIs via social media may provide potential benefits. For example, for an implementation, potential benefits may include a capability of training a POI tagger to recognize POIs in a text from training content, such as in an unstructured text from unlabeled training content. In addition, extending POIs mentioned in social media, such as Twitter®-type messages, for example, with web snippets may allow POIs to be placed in a natural language context. For example, on-line content may be noisy, may include abbreviations, textual shortcuts, or the like, which, at times, may not be sufficiently informative to estimate a model, as was indicated. As such, certain on-line content may, for example, potentially benefit from bootstrapping with web snippets. Also, training on POI mentions extracted from original Wikipedia® articles (e.g., a first paragraph, abstract, etc.) may provide potential benefits, such as, for example, more effectively or efficiently identifying POIs from relatively cleaner (e.g., semantically, etc.) on-line sources, such as news articles, research papers, magazines, or the like, as mentioned above. In addition, by being sufficiently independent of human intervention and performed on relatively dynamic content from the Web, suitable functions or approaches may be continually generated or updated, for example, which may reduce a staleness aspect present in some manually-curated databases of POIs. Of course, a description of certain aspects of bootstrapping POIs via social media or its potential benefits is merely an example, and claimed subject matter is not so limited.

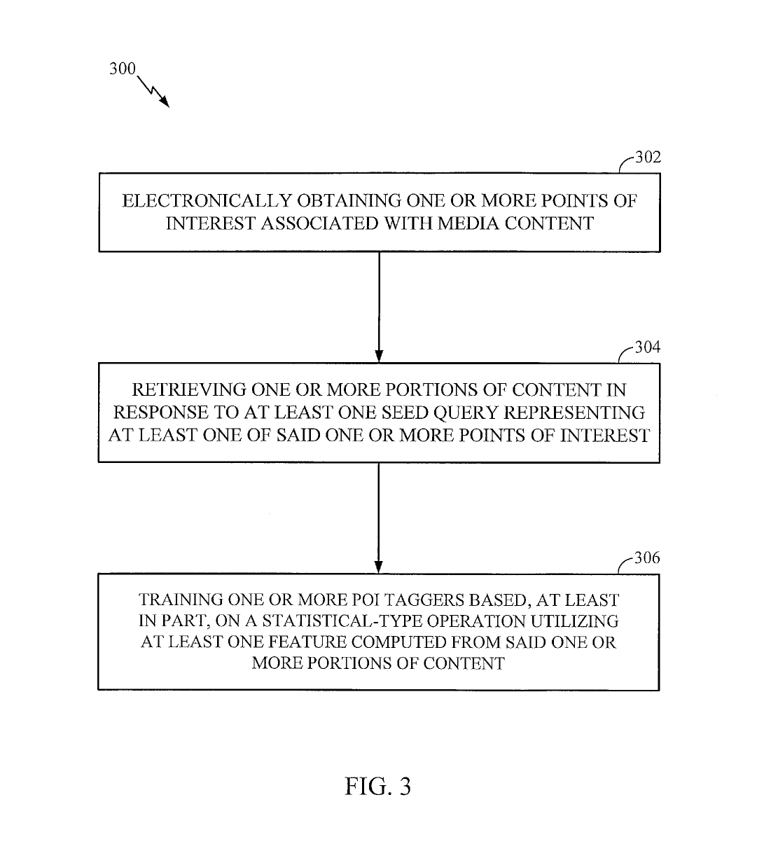

FIG. 3 is a flow diagram illustrating an implementation of an example process 300 that may be performed, in whole or in part, via one or more special purpose computing devices to facilitate or support one or more operations or techniques for identifying suitable POIs in a text, such as an unstructured text in connection with bootstrapping POIs via social media, for example. It should be noted that content applied or produced, such as, for example, inputs, applications, outputs, operations, results, etc. associated with example process 300 may be represented via one or more digital signals.

Example process 300 may, for example, begin at operation 302 with electronically obtaining via communications one or more POIs associated with media content. As previously mentioned, POIs may, for example, be obtained or extracted from suitable media content, such as Wikipedia® articles, Twitter®-type messages generated in connection with a location check-in service (e.g., Gowalla®, Foursquare®, etc.), or the like. With regard to operation 304, one or more portions of content may, for example, be retrieved in response to at least one seed query representing at least one of one or more obtained or extracted POIs. Portions of content may comprise, for example, web snippets of text relevant to a seed POI query and retrieved via a suitable search engine, though claimed subject matter is not so limited. In some instances, one or more portions of content may be obtained from an on-line source, such as original Wikipedia® articles, for example. At operation 306, one or more POI taggers may be trained based, at least in part, on a statistical-type operation utilizing at least one feature computed from one or more retrieved or obtained portions of content. In some instances, a CRF or like sequential tagging operation may, for example, be employed, in whole or in part. Features may, for example, be computed over observations, such as one or more individual tokens, or over state transitions, as was also indicated. POI taggers may be utilized, at least in part, to identify suitable POIs, such as new or previously unseen POIs in a text including an unstructured text, for example, in connection with a search engine or like content management system responsive to search queries, though claimed subject matter is not so limited.

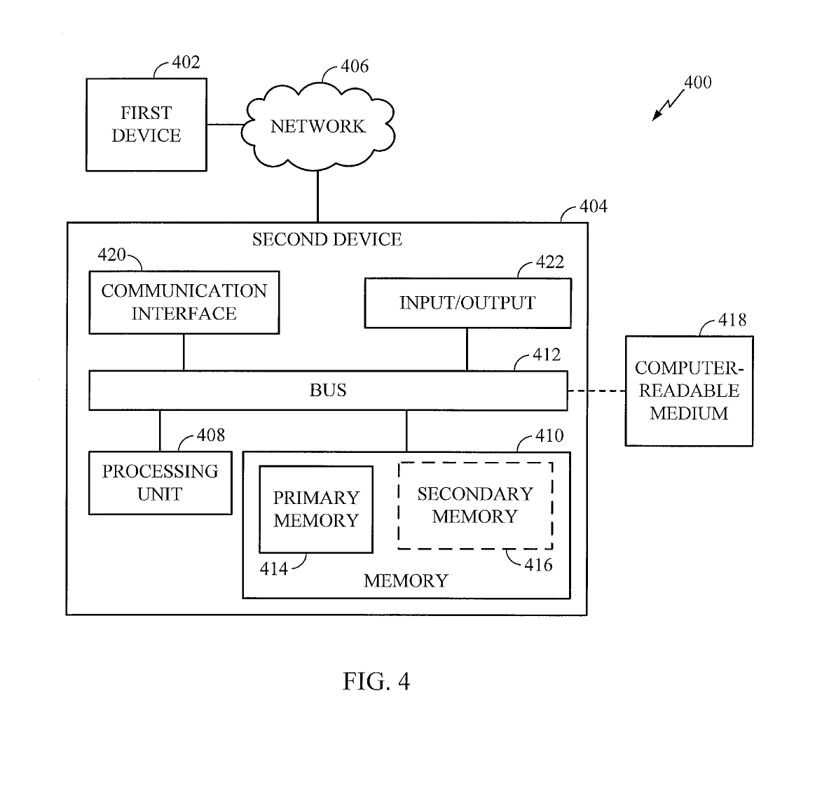

FIG. 4 is a schematic diagram illustrating an example computing environment 400 that may include one or more computing apparatuses or devices capable of implementing, in whole or in part, one or more processes or operations for identifying POIs in an unstructured text, such as in connection with bootstrapping POIs via social media, for example. Computing environment 400 may include, for example, a first device 402 and a second device 404, which may be operatively coupled together via a network 406. In an embodiment, first device 402 and second device 404 may be representative of any electronic device, appliance, or machine that may have capability to exchange content or like signals over network 406. Network 406 may represent one or more communication links, processes, or resources capable of supporting exchange or communication of content or like signals between first device 402 and second device 404. Second device 404 may include at least one processing unit 408 that may be operatively coupled to a memory 410 through a bus 412. Processing unit 408 may represent one or more circuits to perform at least a portion of one or more applicable computing procedures or processes.

Memory 410 may represent any signal storage mechanism or appliance. For example, memory 410 may include a primary memory 414 and a secondary memory 416. Primary memory 414 may include, for example, a random access memory, read only memory, etc. In certain implementations, secondary memory 416 may be operatively receptive of, or otherwise have capability to be coupled to a computer-readable medium 418.

Computer-readable medium 418 may include, for example, any medium that may store or provide access to content or like signals, such as, for example, code or instructions for one or more devices in computing environment 400. It should be understood that a storage medium may typically, although not necessarily, be non-transitory or may comprise a non-transitory device. In this context, a non-transitory storage medium may include, for example, a device that is physical or tangible, meaning that the device has a concrete physical form, although the device may change state. For example, one or more electrical binary digital signals representative of content, in whole or in part, in the form of zeros may change a state to represent content, in whole or in part, as binary digital electrical signals in the form of ones, to illustrate one possible implementation. As such, “non-transitory” may refer, for example, to any medium or device remaining tangible despite this change in state.

Second device 404 may include, for example, a communication adapter or interface 420 that may provide for or otherwise support communicative coupling of second device 404 to a network 406. Second device 404 may include, for example, an input/output device 422. Input/output device 422 may represent one or more devices or features that may be able to accept or otherwise input human or machine instructions, or one or more devices or features that may be able to deliver or otherwise output human or machine instructions.

According to an implementation, one or more portions of an apparatus, such as second device 404, for example, may store one or more binary digital electronic signals representative of content expressed as a particular state of a device such as, for example, second device 404. For example, an electrical binary digital signal representative of content may be “stored” in a portion of memory 410 by affecting or changing a state of particular memory locations, for example, to represent content as binary digital electronic signals in the form of ones or zeros. As such, in a particular implementation of an apparatus, such a change of state of a portion of a memory within a device, such a state of particular memory locations, for example, to store a binary digital electronic signal representative of content constitutes a transformation of a physical thing, for example, memory device 410, to a different state or thing.

Thus, as illustrated in various example implementations or techniques presented herein, in accordance with certain aspects, a method may be provided for use as part of a special purpose computing device or other like machine that accesses digital signals from memory or processes digital signals to establish transformed digital signals which may be stored in memory as part of one or more content files or a database specifying or otherwise associated with an index.

Some portions of the detailed description herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels.

Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other content storage devices, transmission devices, or display devices of the special purpose computer or similar special purpose electronic computing device.

Terms, “and” and “or” as used herein, may include a variety of meanings that also is expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe some combination of features, structures or characteristics. Though, it should be noted that this is merely an illustrative example and claimed subject matter is not limited to this example.

While certain example techniques have been described or shown herein using various methods or systems, it should be understood by those skilled in the art that various other modifications may be made, or equivalents may be substituted, without departing from claimed subject matter. Additionally, many modifications may be made to adapt a particular situation to the teachings of claimed subject matter without departing from the central concept(s) described herein. Therefore, it is intended that claimed subject matter not be limited to particular examples disclosed, but that claimed subject matter may also include all implementations falling within the scope of the appended claims, or equivalents thereof.

What is claimed is:

1. A method comprising:
electronically identifying one or more points of interest (POIs) with respect to a text accessible over an electronic network.

2. The method of claim 1, wherein said text comprises an unstructured text.

3. The method of claim 1, wherein said electronically identifying said one or more POIs comprises electronically obtaining said one or more POIs associated with media content.

4. The method of claim 3, wherein said media content comprises social media content.

5. The method of claim 4, wherein said social media content comprises at least one of the following: an on-line article; a Twitter®-type message generated in connection with a location check-in service; or any combination thereof.

6. The method of claim 3, and further comprising retrieving one or more portions of content in response to at least one seed query representing at least one of said one or more POIs.

7. The method of claim 6, wherein said one or more portions of content comprises one or more web snippets of text at least partially providing a context in which said one or more POIs are used.

8. The method of claim 6, and further comprising training one or more POI taggers based, at least in part, on a statistical-type operation.

9. The method of claim 8, wherein said statistical-type operation comprises a sequential tagging operation.

10. The method of claim 9, wherein said sequential tagging operation comprises a conditional random field (CFR) operation utilizing at least one feature computed from said one or more portions of content.

11. The method of claim 10, wherein said at least one feature comprises a binary feature.

12. The method of claim 11, wherein said binary feature comprises at least one of the following: a lexical feature; a geographic feature; a grammatical feature; a statistical feature; a state transition feature; or any combination thereof.

13. The method of claim 9, wherein said sequential tagging operation comprises a CFR operation utilizing at least one feature computed in connection with one or more segmenting operations with respect to at least one of the following: a paragraph of an on-line article; an abstract of an on-line article; or any combination thereof.

14. The method of claim 8, wherein said one or more POI taggers are trained using at least one of the following: an unlabeled training content; a labeled training content; or any combination thereof.

15. A method comprising:
electronically employing a bootstrapping scheme to identify one or more POIs in an unstructured text, said bootstrapping scheme is employed using one or more machine-learned models and further comprising:
computing one or more features associated with one or more tokens representative of said one or more POIs; and
classifying said one or more tokens as being at least one of said one or more POIs based, at least in part, on said one or more features.

16. The method of claim 15, wherein said bootstrapping scheme is employed in connection with social media.

17. The method of claim 15, wherein said one or more tokens are represented via a vector of binary features.

18. The method of claim 15, wherein said one or more tokens comprises at least one of the following: one or more labeled tokens; one or more unlabeled tokens; or any combination thereof.

19. An article comprising:
a non-transitory storage medium having instructions stored thereon executable by a special purpose computing platform to:
identify a second representation of a POI name in an unstructured text based, at least in part, on a first representation of said POI name bootstrapped via social media.

20. The article of claim 19, wherein said non-transitory storage medium further comprises instructions to extract said first representation of said POI name from at least one of the following: an on-line article; a short informal message; or any combination thereof.

21. The article of claim 19, wherein said non-transitory storage medium further comprises instructions to compute at least one feature based, at least in part, on said first representation of said POI name bootstrapped via said social media.

22. The article of claim 21, wherein said non-transitory storage medium further comprises instructions to train a CRF-type learner operation in connection with said at least one computed feature to establish a POI tagger.
